(19) United States
(12) Patent Application Publication
(10) Pub. No.: US 2021/0397645 A1
(43) Pub. Date: Dec. 23, 2021

(54) IMAGE SEARCH METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Xiangmin WANG, Shenzhen (CN); Zefeng LIANG, Shenzhen (CN); Qiang YAN, Shenzhen (CN); Qingyang ZHANG, Shenzhen (CN); Chuangmu YAO, Shenzhen (CN); Ge WANG, Shenzhen (CN); Jiayi DING, Shenzhen (CN); Zhenhong CHEN, Shenzhen (CN); Meng ZHAO, Shenzhen (CN); Qian BAI, Shenzhen (CN); Hang ZHAO, Shenzhen (CN); Wenfeng ZHU, Shenzhen (CN); Keliang SUN, Shenzhen (CN); Qiaoying LIN, Shenzhen (CN); Dandan CHEN, Shenzhen (CN); Xiumin LIN, Shenzhen (CN); Ming ZOU, Shenzhen (CN); Jiamin CHEN, Shenzhen (CN); Huawei ZHANG, Shenzhen (CN); Zhihao CHEN, Shenzhen (CN); Yurun MO, Shenzhen (CN); Jiawen ZHONG, Shenzhen (CN); Mu YUAN, Shenzhen (CN); Fu ZOU, Shenzhen (CN)

(73) Assignee: TENCENT TECHNOLOGY (SHENZHEN) COMPANY LIMITED, Shenzhen (CN)

(21) Appl. No.: 17/446,861

(22) Filed: Sep. 3, 2021

Related U.S. Application Data
(63) Continuation of application No. PCT/CN2020/095240, filed on Jun. 10, 2020.

(30) Foreign Application Priority Data
Jun. 12, 2019 (CN) 201910507945.5

(51) Int. Cl. G06F 16/532; G06K 9/62; G06F 3/0482; G06F 3/0484; H04L 12/58; G06F 3/16; G06F 16/538; G06F 16/2457; G06F 16/583

(52) U.S. Cl. CPC G06F 16/532; G06K 9/6215; G06F 3/0482; G06F 3/0484; H04L 51/046; G06F 3/04817; G06F 3/167; G06F 16/538; G06F 16/24578; G06F 16/5846; G06F 3/04847

(57) ABSTRACT

An image search method is provided. In the method, an image selection page of a messaging application is displayed. An input image for a search is determined based on an operation performed by a user on the image selection page. A search is performed for at least one output image similar to the input image based on a plurality of types of image characteristics that indicate levels of similarity between images. Each of the ay least one output image is determined to be similar to the input image based on at least one of the types of image characteristics. A search result list is generated according to the at least one output image. Further, the search result list is displayed.

### RELATED APPLICATIONS

This application is a continuation of International Application No. PCT/CN2020/095240, entitled “METHOD AND DEVICE FOR IMAGE SEARCH, COMPUTER APPARATUS, AND STORAGE MEDIUM” and filed on Jun. 10, 2020, which claims priority to Chinese Patent Application No. 201910507945.5, entitled “IMAGE SEARCH METHOD AND APPARATUS, COMPUTER DEVICE, AND STORAGE MEDIUM” and filed on Jun. 12, 2019. The entire disclosures of the prior applications are hereby incorporated by reference in their entirety.

### FIELD OF THE TECHNOLOGY

This disclosure relates to the field of Internet technologies, including to an image search method and apparatus, a computer device, and a storage medium.

### BACKGROUND OF THE DISCLOSURE

An instant messaging (IM) application is software for implementing online chatting and communication by using instant messaging technologies. Users can exchange messages with each other by using the IM application to chat. At present, to enhance the enjoyment of chatting, the IM application can also support transmitting images, such as stickers, to interact with a chat partner. However, there is no solution of searching, for images by image in the related art.

### SUMMARY

Embodiments of this disclosure include an image search method and apparatus, a computer device, and a not computer-readable storage medium, to search for images by image in an application, such as a messaging application.

The embodiments of this disclosure provide an image search method. In the method, an image selection page of a messaging application is displayed. An input image for a search is determined based on an operation performed by a user on the image selection page. A search is performed for at least one output image similar to the input image based on a plurality of types of image characteristics that indicate levels of similarity between images. Each of the at least one output image is determined to be similar to the input image based on at least one of the types of image characteristics. A search result list is generated according to the at least one output image. Further, the search result list is displayed.

The embodiments of this disclosure further provide another image search method. In the method an image search request is received from a terminal. An input image for a search is determined based on the received image search request. A search is performed for at least one output image similar to the input image based on a plurality of types of image characteristics that indicate levels of similarity between images. Each of the at least one output image is determined to be similar to the input image based on at least one of the types of image characteristics. A search result list is generated according to the at least one output image. Further, the search result list is provided to the terminal, the search result list being displayed on an interface of a messaging application.

The embodiments of this disclosure further provide an image search apparatus. The image search apparatus includes processing circuitry configured to display an image selection page of a messaging application, and determine an input image for a search based on an operation performed by a user on the linage selection page. The processing circuitry is configured to search for at least one output image similar to the input image based on a plurality of types of image characteristics that indicate levels of similarity between images. Each of the at least one output image is determined to be similar to the input image based on at least one of the types of image characteristics. Further, the processing circuitry is configured to generate a search result list according to the at least one output image, and display the search result list.

The embodiments of this disclosure further provide another image search apparatus. The processing circuitry is configured to receive an image search request from a terminal, and determine an input image for a search based on the received image search request. The processing circuitry is configured to search for at least one output image similar to the input image based on a plurality of types of image characteristics that indicate levels of similarity between images. Each of the at least one output image is determined to be similar to the input image based on at least one of the types of image characteristics. The processing circuitry is configured to generate a search result list according to the at least one output image. Further, the processing circuitry is configured to provide the search result list to the terminal, the search result list being displayed on an interface of a messaging application.

The embodiments of this disclosure further provide a computer device, including a memory, a processor, and a computer program stored on the memory and executable on the processor, the processor, when executing the program, performing the steps of any one of the image search methods according to the embodiments of this disclosure.

In addition, the embodiments of this disclosure further provide a non-transitory computer-readable storage medium, storing instructions which when executed by a processor cause the processor to perform any one of the image search methods according to the embodiments of this disclosure.

### BRIEF DESCRIPTION OF THE DRAWINGS

To describe the technical solutions the embodiments of this disclosure more clearly, the following briefly describes accompanying drawings required for describing the embodiments. The accompanying drawings in the following description show merely some embodiments of this disclosure, and a person skilled in the art may still derive other drawings from these accompanying drawings.

FIG. 1a is a schematic diagram of a scenario of an image search method according to an embodiment of this disclosure.

FIG. 1b is a flowchart of an image search method according to an embodiment of this disclosure.

FIG. 1c is a schematic diagram of a page operation of searching for an output sticker according to an embodiment of this disclosure.

FIG. 1d is a schematic diagram of a content search page according to an embodiment of this disclosure.

FIG. 1e is a schematic diagram of triggering display of a sticker search page according to an embodiment of this disclosure.

FIG. 1f is a schematic diagram of transmitting an output sticker according to an embodiment of this disclosure.

FIG. 2a is a schematic diagram of another page operation of searching for an output sticker according to an embodiment of this disclosure.

FIG. 2b is a schematic diagram of another page operation of searching for an output sticker according to an embodiment of this disclosure.

FIG. 2c is a schematic diagram of another page operation of searching for an output sticker according to an embodiment of this disclosure.

FIG. 2d is a schematic diagram of another page operation of searching for an output sticker according to an embodiment of this disclosure.

FIG. 2f is a flowchart of an image search method according to another embodiment of this disclosure.

FIG. 3a is a flowchart of an image search method according to still another embodiment of this disclosure.

FIG. 3b is a schematic architectural diagram of searching for an output sticker according to an embodiment of this disclosure.

FIG. 3c is a schematic flowchart of feature extraction according to an embodiment of this disclosure.

FIG. 3d is a schematic diagram of matching an output sticker according to an embodiment of this disclosure.

FIG. 3e is a schematic diagram of ranking output stickers according to an embodiment of this disclosure.

FIG. 4a is a schematic diagram of a list of output stickers according to an embodiment of this disclosure.

FIG. 4b is a schematic diagram of another list or output stickers according to an embodiment of this disclosure.

FIG. 4c is a schematic diagram of another list of output stickers according to an embodiment of this disclosure.

FIG. 5a is a schematic structural diagram of an image search apparatus according to an embodiment of this disclosure.

FIG. 5b is another schematic structural diagram of an image search apparatus according to an embodiment of this disclosure.

FIG. 6 is another schematic structural diagram of an image search apparatus according to an embodiment of this disclosure.

FIG. 7 is a schematic structural diagram of a computer device according to an embodiment of this disclosure.

### DESCRIPTION OF EMBODIMENTS

The technical solutions in embodiments of this disclosure are described in further detail in the following with reference to the accompanying drawings in the embodiments of this disclosure. The described embodiments are merely some rather than all of the embodiments of this disclosure. All other embodiments obtained by a person skilled in the art based on the embodiments of this disclosure shall fall within the protection scope of this disclosure.

Embodiments of this disclosure provide an image search method and apparatus, a computer device, and a storage medium. For example, the embodiments of this disclosure provide an image search apparatus (which may be referred to as a first image search apparatus for distinction) adapted to a first computer device, and an image search apparatus (which may be referred to as a second image search apparatus ism distinction) adapted to a second computer device. The first computer device may be a device such as a terminal, and the terminal may be a device such as a mobile phone, a tablet computer, or a notebook computer. The second computer device may be a network-side device such as a server.

For example, the first image search apparatus may be integrated in a terminal, and the second image search apparatus may be integrated in a server. The server may be a single server or a server cluster including a plurality of servers.

In the embodiments of this disclosure, an example in which the first computer device is a terminal and the second computer device is a server is used to introduce an image search method.

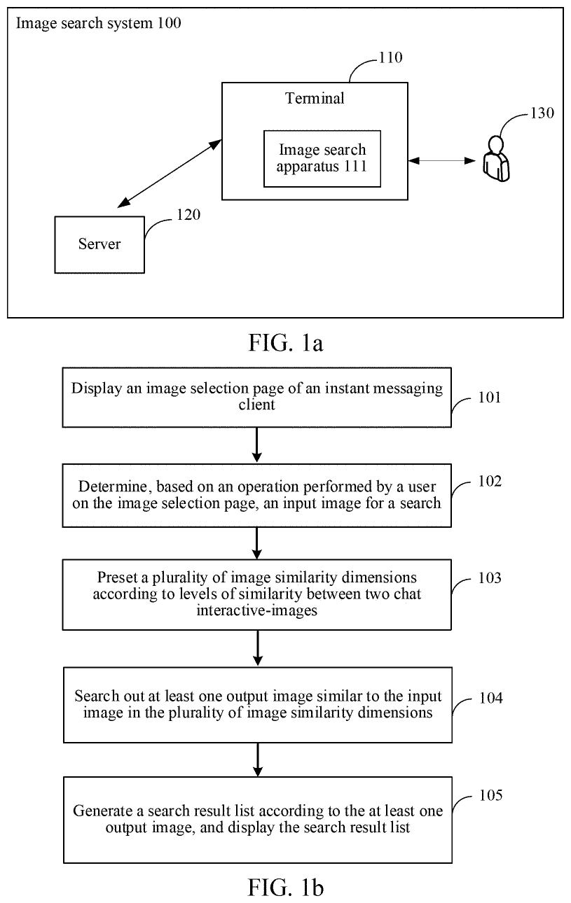

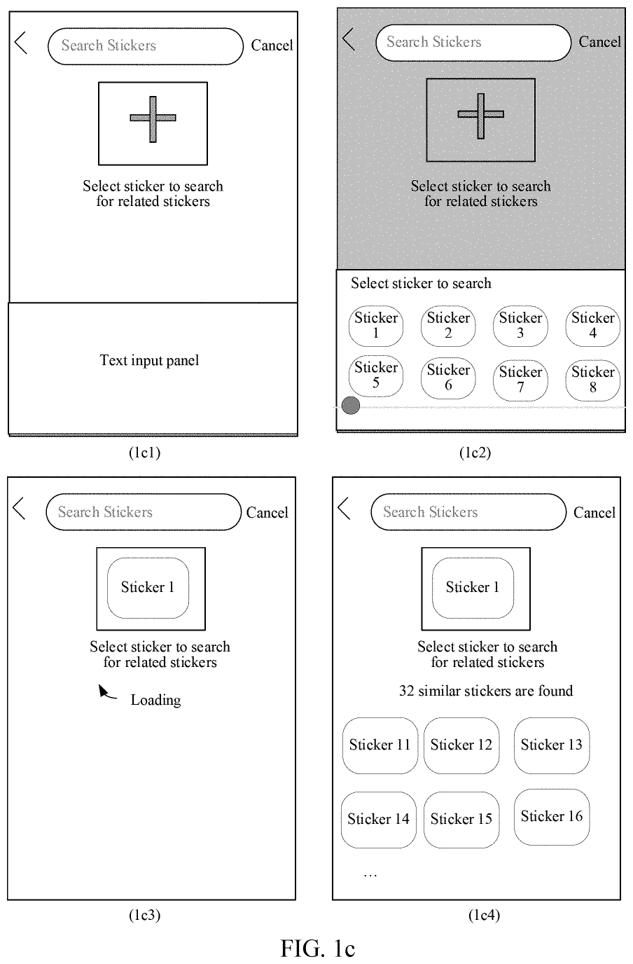

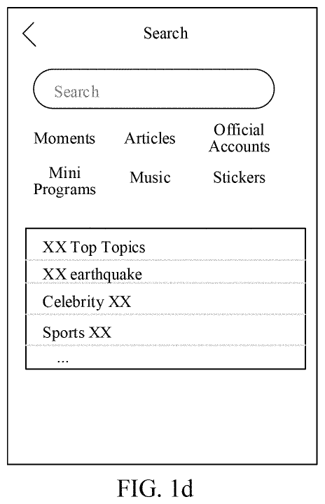

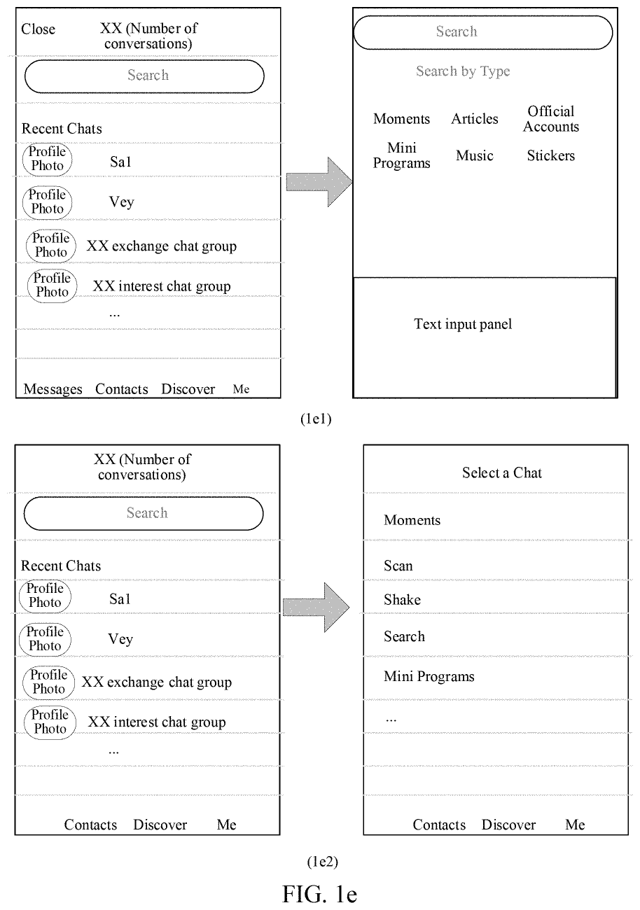

Referring to FIG. 1a, the embodiments of this disclosure provide an image search system 100 including a terminal 110, a server 120, and the like. The terminal 110 and the server 120 are connected through a network, for example, a wired or wireless network. An image search apparatus 111 is integrated in the terminal 110, for example, integrated in the terminal 110 in the form of a client. The terminal 110 can be configured to display an image selection page of a messaging application, such as an instant messaging (IM) client; determine, based on an operation performed by a user on the image selection page, an input image for a search; preset a plurality of image similarity dimensions according to levels of similarity between two chat interactive-images; search out at least one output image similar to the input image in the plurality of image similarity dimensions, each output image being similar to the input image in at least one image similarity dimension; and generate a search result list according to the at least one output image, and display the search result list.

There are many ways for the terminal 110 to trigger a search for an output image. For example, the terminal 110 may trigger the server 120 to search for an output image similar to the input image in a plurality of image similarity dimensions. The terminal 110 may transmit an image search request to the server 120.

The serer 120 may be specifically configured to: determine, based on an image search request transmitted by a terminal, an input image for a search; preset a plurality of image similarity dimensions according to levels of similarity between two chat interactive-images; search out at least one output image similar to the input image in the plurality of image similarity dimensions, each output image being similar to the input image in at least one image similarity dimension; generate a search result list according to the at least one output image and return the search result list to the terminal, to cause the terminal to display the search result list on an interface of an IM client.

The embodiments of this disclosure are described from the perspective of the first image search apparatus. For example, the first image search apparatus may be integrated in the terminal. An embodiment of this disclosure provides an image search method. The method may be performed by a processor of the terminal 110 shown in FIG. 1a. As shown in FIG. 1b, a specific process of the image search method can include the following steps.

In step 101, an image selection page of an application, such as an IM client or other type of messaging application, is displayed.

The image in this embodiment of this disclosure may include an interactive image of an application in an IM client, or an interactive image used by a user in an IM client, for example, a chat interactive-image. The chat interactive-image is an image that is used for interacting with a chat partner in a chat scenario, and for example, may include an image that conveys information, such as an emotion and language, to a chat partner in a chat conversation. For example, the chat interactive-image may include a sticker and the like. There may be a plurality of types of chat interactive-images, including, for example, a static image or a dynamic image. For example, the chat interactive-images may include a static sticker, a dynamic sticker, and the like.

In this embodiment of this disclosure, before the image selection page is displayed, an image search page may be displayed. The image search page may be a search page for a user to search for images by image. The user may perform an operation on the image search page to trigger searching for an output image by image (e.g., related image search). For example, the image search page may be a page for the user to search for chat interactive-images by chat interactive-image, and the user can perform a reverse image search operation on the page. For example, the image search page may be a sticker search page, and the user can perform a search operation on the sticker search page to search for a desired output sticker by sticker (e.g., related sticker search), as shown in FIG. 1c.

The image search page may include an image selection control. The image selection control can be used by the user to trigger display of an image selection page for determining an input image. The control can be in the form of an icon, an input box, a button, or the like.

For example, referring to FIG. 1c, an image is a sticker. A sticker search page 1c1 may include an image selection control, that is, a “+” plus button. When the user needs to select an input sticker for a search, the user performs an operation on, for example, clicks or taps, or slides, the plus button, to trigger display of a sticker selection page 1c2. In the sticker selection page 1c2, a sticker selection panel including a list of to-be-selected stickers is displayed. The list of to-be-selected stickers includes stickers added to favorites by the user. The sticker selection panel for the user to select or determine the input sticker.

In this embodiment of this disclosure, the user may perform an operation the user operation page of the IM client to trigger display of the image search page of the IM client such as a sticker search page 1c1. For example, in an embodiment, the user may perform an operation on a content search page of the IM client to trigger display of the image search page. The content search page may be a page for the user to search for content, for example, news, articles, applications such as mini programs, services, and images (e.g., chat interactive-images). The user can perform a search operation on the content search page to search for desired content.

For example, a chat interactive-image search control may be set on the content search page, so that the user can trigger display of the image search page by performing an operation on the control. The method may include: displaying a content search page of the IM client, the content search page including an image search control; displaying an image search page of the client in response to detecting a trigger operation of the user on the image search control, the imago search page including an image selection control; and displaying the image selection page in response to detecting a trigger operation of the user on the image selection control.

For example, an image is a sticker. Referring to FIG. 1d, the terminal may display the content search page of the IM client. The content search page may include a plurality of content search controls such as an article search control, a mini program search control, a music search control, an official account search control, and a sticker search control. In addition, the content search page may also include top topics and the like in the IM client. When the user needs to search for a sticker, the user can select the sticker search control such as by performing an operation on, for example, clicks or taps, or slides, the sticker search control in the content search page. When detecting an operation of the user on the sticker search control, the terminal triggers display of the sticker search page 1c1 shown in FIG. 1c.

In this embodiment of this disclosure, there may be a plurality of ways to trigger display of the content search page. For example, the user may perform an operation on a chat conversation list page to trigger display of the content search page. For example, a content search control can be set on the chat conversation list page, and the user may perform an operation on the control to trigger display of the content search page. The method may include: displaying a chat conversation list page of the IM client, the chat conversation list page including a content search control; and displaying the content search page in response to detecting a trigger operation of the user on the content search control.

The chat conversation list page is a page used for displaying a chat conversation list, and the chat conversation list may include one or more chat conversations (e.g., a private chat and a group chat). For example, referring to FIG. 1e, the terminal displays a chat conversation list page of the IM client, for example, a page on the left in sub-figure 1e1, where a global content search control is set on the page. When the user performs an operation on, for example, clicks or taps, or slides, the global content search contrail, the terminal displays a content search page on the right in sub-figure 1e1.

In another example, the user may perform an operation on the function page of the IM client to trigger display of the content search page. For example, a search function control can be set on the function page, and the user may perform an operation on the control to trigger display of the content search page. The method may include: displaying a function page of the IM client, the function page including a search function control; and displaying the content search page in response to detecting a trigger operation of the user on the search function control.

For example, referring to FIG. 1e, the terminal displays a chat conversation list page of the TM client, for example, a page on the left in sub-figure 1e2, where a global content search control is set on the page. When the user performs an operation on the global content search control, the terminal displays a function page on the right in sub-figure 1e2, for example, a “Discover” page. The page includes function controls such as a code scanning function control “Scan”, a content publishing function control “Moments”, a mini program function control “Mini Programs”, and a search function control “Search”. When the user performs an operation on, for example, clicks or taps, or slides, the search function control “Search”, the terminal displays the content search page shown in FIG. 1d.

In step 102, based on an operation performed by a user on the image selection page, an input image for a search is determined.

The input image determining operation performed on the image selection page may be a single operation. For example, the user performs a single click or tap operation on the selection page. The input image determining operation may also be an operation including a plurality of operations such as a series of operations. For example, the user performs a plurality of different operations on the selection page.

In step 103, a plurality of image similarity dimensions according to levels of similarity between two chat interactive-images are preset. For example, the plurality to f image similarity dimensions can correspond to a plurality of types of image characteristics that indicate levels of similarity between images

In step 104, a search for at least one output image similar to the input image in the plurality of image similarity dimensions is performed, each output image being similar to the input image in at least one image similarity dimension. For example, searching is performed for at least one output image similar to the input image based on a plurality of types of image characteristics that indicate levels of similarity between images, each of the at least one output image being determined to be similar to the input image based on at least one of the types of image characteristics.

In step 105, a search result list is generated according to the at least one output image, and the search result list is displayed.

The way of displaying the search result list may be related to the way of determining the input image. The following describes several types of display of search results in different ways of determining an input image:

(1): The user selects the input image from a list of to-be-selected images on an image selection page.

The image selection page may include a list of to-be-selected images, and the list of to-be-selected images may include at least one to-be-selected image. For example, an image is a sticker. The list of to-be-selected images may be a list of to-be-selected stickers, and the list of to-be-selected stickers may include at least one to-be-selected sticker. For example, the list of to-be-selected images may include at least one of snickers such as a sticker added to favorites by the user on the client, a default sticker in the client, and a sticker added by the user from a sticker gallery. For example, the list of to-be-selected images may include at least one sticker added to favorites by the user.

In this case, when an image selection operation of the user on a to-be-selected image in the list of to-be-selected images is detected, the to-be-selected image selected by the user is determined as the input image, and a search result list is displayed.

For example, referring to FIG. 1c, after the user performs an operation on an image selection control, that is, a “+” plus button, in an image search page 1c1 to trigger display of a sticker selection panel at the bottom of an image selection page 1c2, the user may click or tap to select “Sticker 1” from the sticker selection panel as the input sticker. When the user clicks or taps to select “Sticker 1”, a search result list is displayed, and the search result list includes stickers similar to “Sticker 1”, for example, Sticker 11 and Sticker 12.

(2): The user obtains the input image through capturing.

The image selection page may include an image capture control. In this case, when a trigger operation of the user on the image capture control is detected, an image capture page is displayed. A capture result page is displayed based on a capture operation of the user on the image capture page, the capture result page including a capture result image and an image confirmation control. When a confirmation operation of the user an the image confirmation control is detected, the capture result image is determined as the input image.

The image capturing may be photo capturing, video capturing, or the like.

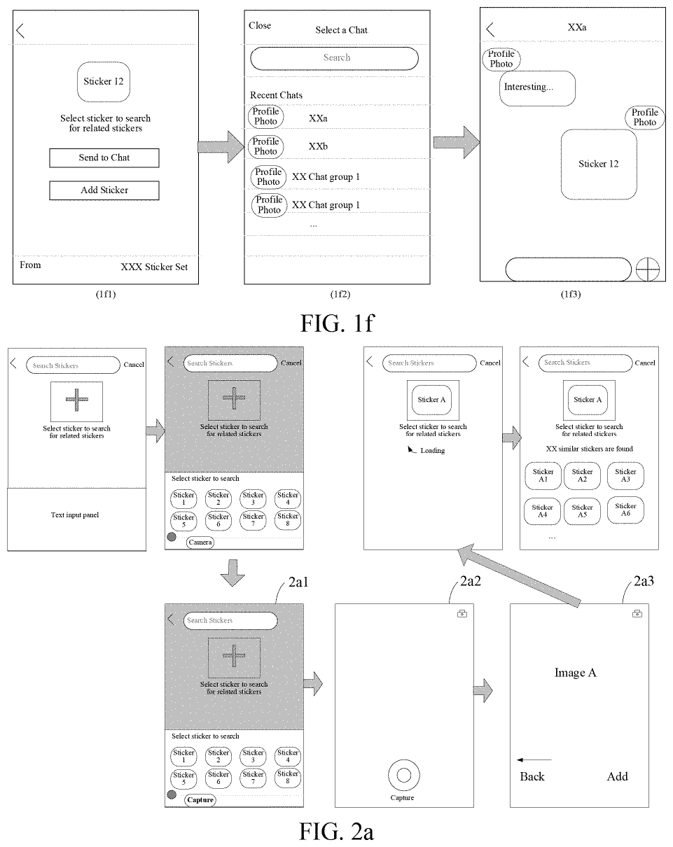

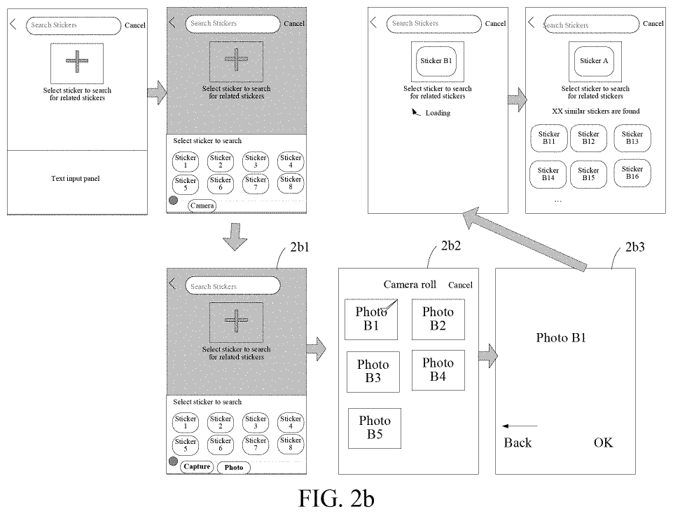

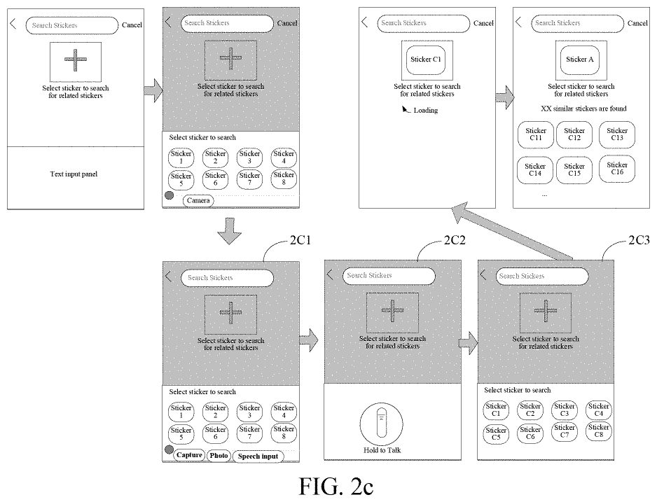

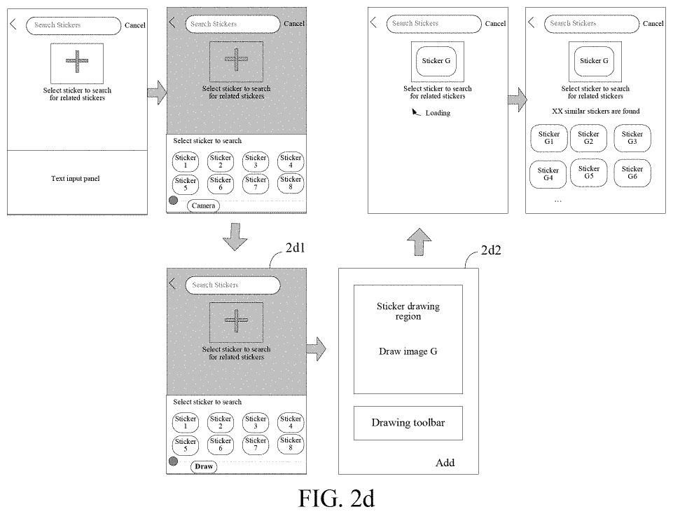

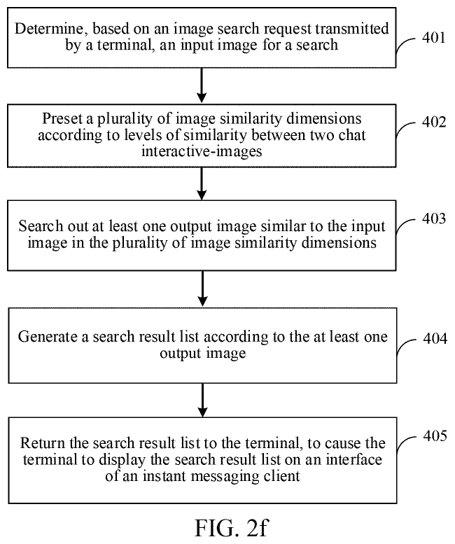

For example, referring to FIG. 2a, an image is a sticker. The sticker selection panel at the bottom of a sticker selection page 2a1 may further include an image capture control such as a “Capture” button. When the user wants to select an input sticker through capturing (i.e., use a captured image as an input sticker), the user may perform an operation on, for example, clicks or taps, or slides, the “Capture” button. In this case, the terminal calls a camera to display an image capture page 2a2, and then, the user may perform an operation on the image capture page 2a2 to capture a desired image. For example, the user can click the Capture button on the image capture page 2a2, and the terminal displays a capture result page 2a3. This page includes a captured image, such as an image A, and an image confirmation control “Add” button. When the user wants to use the captured image A as the input sticker, the user may perform an operation on the “Add” button. In this case, the terminal uses the captured Image A as the input sticker and displays a search result list. The search result list includes stickers similar to the image A, such as a similar sticker A1 and a similar sticker A2. In an embodiment, when the user performs an operation on the “Add” button, the terminal may alternatively add the image A to a sticker library of the user, for example, add the image A to favorites.

(3) The user selects a photo from a local album as the input image.

The image selection page may include a Photo selection control. In this case, when a trigger operation of the user on the photo selection control is detected, a photo selection page is displayed, the photo selection page including at least one photo in a local album. A photo selected by the user is labeled in the photo selection page based on a photo selection operation of the user on the photo selection page, and a photo confirmation page is displayed, the photo confirmation page including a photo confirmation control. When a confirmation operation of the user on the photo confirmation control is detected, the photo selected by the user is determined as the input image.

For example, referring to FIG. 2b, the sticker selection panel at the bottom of a sticker selection page 2b1 may further include a photo selection control, for example, a “Photo” button. When the user wants to select a photo from a local album as the input sticker, the user can perform an operation on, for example, clicks or taps, or slides, the “Photo” button. In this case, the terminal displays a photo selection page 2b2, and the photo selection page 2b2 includes at least one photo in the local album. The user may select a photo through an operation on the photo selection page 2b2, and the terminal may label the photo selected by the user. For example, when the user selects a photo B1 through a click or tap operation, the user may click the photo B1. When the user wants to use the selected photo B1 as the input sticker, the user may click or tap a photo confirmation control in a photo confirmation page 2b3, for example, an “OK” button. In this case, the terminal uses the photo selected by the user as the input sticker and displays a search result list. The search result list includes stickers similar to the photo B1, for example, a similar sticker B11 and a similar sticker B12. In an embodiment, when the user performs an operation on the “OK” button, the terminal may further add the photo B1 to a sticker library of the user, for example, the photo B1 to favorites.

(4) The user determines the input image by speech.

The image selection page may include a speech selection control. In this case, when a trigger operation of the user on the speech selection control is detected, a speech input page is displayed, the speech input page including a speech input control. When a speech input operation of the user on the speech input control is detected, speech information inputted by the user is acquired. When a speech input end operation of the user on the speech input control is detected, candidate images matching the speech information are displayed. When a selection operation of the user on a candidate image is detected, the candidate image selected by the user is determined as the input image.

The candidate images may be candidate images matching speech information in a local database of the terminal, for example, candidate images matching the speech information in a local sticker library. That the image matches the speech information may include that text content in the image matches speech content, that a meaning or attribute content of the image matches the speech content, and so on.

For example, referring to FIG. 2c, the sticker selection panel at the bottom of an image selection page 2c1 may further include a speech selection control, for example, a “Speech Input” button. When the user wants to select an image by speech as the input sticker, the user may perform an operation on, for example, click or tap, or slide the “Speech Input” button. In this case, the terminal displays a speech input page 2c2. The speech input page 2c2 includes a speech input control, for example, a microphone icon. The user may perform an operation on the microphone icon in the speech input page 2c2. For example, when the user presses and holds the microphone icon, acquisition of speech information inputted by the user is triggered. When the user ends the press-and-hold operation, the terminal may display a sticker selection page 2c3. The sticker selection page 2c3 includes candidate stickers matching the speech information in a local sticker library for example, a sticker C1, a sticker C2, and a sticker C3. The user may select a candidate sticker as the input sticker on the sticker selection page 2c3. For example, the user may select a candidate sticker C1 through a click or tap operation. In this case, the terminal displays a search result list. The search result list includes stickers similar to the sticker C1, for example, a similar sticker C11 and a similar sticker C12.

(5) The user determines the input image through image drawing, in other words by drawing the image.

The image selection page ma include an image drawing control. In this case, when a trigger operation of the user on the image drawing control is detected, an image, drawing page is displayed, the image drawing page including an image drawing region and a drawn-image confirmation control. An image drawn by the user is displayed on the image drawing page based on a drawing operation of the user in the image drawing region. When a confirmation operation on the drawn-image confirmation control is detected, the image drawn by the user is determined as the input image.

For example, referring to FIG. 2d, the sticker selection panel at the bottom of an image selection page 2d1 may further include a drawing control, for example, an icon in the shape of a “paintbrush”. When the user wants to determine the input sticker through image drawing, the user may perform an operation on, for example, click or tap, or slide, the “Draw” icon. In this case, the terminal displays a sticker drawing page 2d2. The sticker drawing page 2d2 includes a sticker drawing region and a drawn-image confirmation control such as an “Add” button. The user may perform a drawing operation in the sticker drawing region. For example, the user may use a corresponding color, style, and line to draw a desired sticker in the sticker drawing region. After the user draws a sticker G, the user may perform an operation on the drawn-image confirmation control such as the “Add” button. In this case, the terminal uses the sticker drawn by the user as the input sticker and displays a search result list. The search result list includes stickers similar to the sticker G, for example, a similar sticker G1 and a similar sticker G2. In an embodiment, when the user performs an operation on the “Add” button, the terminal may further add the drawn sticker G to a sticker library of the user, for example, add the sticker G to favorites.

The foregoing input image selection methods can be used in various combinations, so that the user can select the input image for a search in a variety of ways. For example, the sticker selection panel may include at least one of a to-be-selected sticker, an image capture control, a photo selection control, a speech selection control, and an image drawing control.

In an embodiment, in consideration that image searching requires the user to wait for a specific period of time, to prevent user experience from being degraded by the anxiety of the user waiting, a search loading page may also be displayed. Therefore, the method further includes: displaying the input image and a search result loading icon on a search loading page of the IM client.

In step 105, in which a search result list is generated according to the at least one output image and the search result list is displayed, the search result list can be displayed on a search result page when the search succeeds.

For example, referring to FIG. 1c, when the user selects the input sticker, the terminal displays a sticker search loading page 1c3. The search loading page 1c3 includes an input sticker selected or determined by the user, and a search reset loading icon. The search result loading icon can be set, according to actual needs, to, for example, a circular loading icon or a long-strip loading icon (e.g., a progress bar).

In this embodiment of this disclosure, the search result list may include an output image that is similar to the input image in at least one (e.g., one or more) image similarity dimension. For example, the search result list may include an output sticker that is similar to the input sticker in at least one sticker similarity dimension.

In an embodiment of this disclosure, the step 103, in which a plurality of image similarity dimensions are preset according to levels of similarity between two chat interactive-images may include pre-obtaining a plurality of chat interactive-images used in the IM client; and layering information included in the plurality of chat interactive-images, and setting the plurality of image similarity dimensions to any of a text content dimension, a meaning dimension, a role dimension, an action dimension, and a conversational relationship dimension.

The image similarity dimension, or characteristic, can be a similarity type, a similarity aspect, a similarity level, or the like of similarity between two chat interactive-images. In the embodiments of this disclosure, similarity between images includes that the images are the same and/or the images are similar, which may be specifically selected according to actual needs.

Image similarity dimensions can be divided into a plurality of types according to actual needs, that is, there can be a plurality of levels of similarity between two chat interactive-images, for example, including similarity types such as image similarity, meaning similarity, and conversational relationship similarity. For example, the similarity between two chat interactive-images may be image similarity, meaning similarity, conversational relationship similarity, or the like.

For example, the image similarity dimension, may include, but is not limited to, the following dimensions: a text content dimension, a meaning dimension, a role dimension, an action dimension, and a conversational relationship dimension. The text content dimension of an image can indicate, for example, texts of two chat interactive-images are the same or similar. The meaning dimension of an image can indicate, an example, meanings conveyed by two chat interactive-images are the same or similar. The role dimension of an image can indicate, for example, roles in two chat interactive-images are the same or similar. The action dimension of a role in an image can indicate, for example, actions of roles in two chat interactive-images are the same or similar. The conversational relationship dimension in an image, including conversational relationship similarity between pieces of text content or conversational relationship similarity between meanings conveyed by images, can indicate, for example, pieces of text content in two chat interactive-images form a conversational relationship.

For example, using a sticker as an example, a sticker similarity dimension may include, but is not limited to, the following dimensions: a text content dimension, a meaning dimension, a role dimension, an action dimension, and a conversational relationship dimension.

The text content dimension of a sticker is where, for example, texts of two stickers are the same or similar.

The meaning dimension of a sticker is where, for example, meanings conveyed by two stickers are the same or similar, and for example, both slickers are slickers conveying “hello”; or one conveys “hello” and another conveys “bonjour”.

The role dimension of a slicker Is where, for example, roles in two stickers are the same or similar, and for example, virtual roles in two stickers both are cartoon images of “XX baby”.

The action dimension of a role of a sticker is where, for example, actions of roles in two stickers are the same or similar, and for example, roles in two stickers both make a gesture of “victory”, or a role in one sticker makes an action of “covering the face”, and a role in another sticker makes an action of “covering the mouth”.

A conversational relationship dimension of a sticker, including conversational relationship similarity between pieces of text content, is where, for example, pieces of text content in two stickers form a conversational relationship, and for example, if text content of one slicker is “What's your problem”, and text content of another sticker is “You tell me”, then the two slickers have conversational relationship similarity.

For example, a search for output images similar to the input image in a plurality of image similarity dimensions may be triggered to obtain an output image set. The output image set may include output images that are similar to the input image in each image similarity dimension. In an embodiment, there may be a plurality of timings for triggering the search for the output image. For example, after the input image is obtained, the search for an output image similar to the input image may be triggered. In another example, a search for an output image similar to the input image may be triggered while the input image is obtained.

For example, in an embodiment, when the user performs a selection operation on the list of to-be-selected images, a search for images may be triggered. The method may include triggering a search for an output image similar to the input image in a plurality of image similarity dimensions in response to detecting a selection operation of the user on a to-be-selected image in the list of to-be-selected images.

In another example, a search for an output image similar to the input image in a plurality of image similarity dimensions is triggered when a confirmation operation of the user on an image confirmation control is detected.

In another example, a search for an output image similar to the input image in a plurality of image similarity dimensions is triggered when a confirmation operation of the user on a photo continuation control is detected.

In another example, a search for an output image similar to the input image in a plurality of image similarity dimensions is triggered when a selection operation of the user on candidate images is detected.

In another example, a search for an output image similar to the input image in a plurality of matte similarity dimensions is triggered when a confirmation operation of the user on a drawn-image confirmation control is detected.

For example, referring to FIG. 1c, after a sticker selection panel is displayed, the user may click or tap to select “Sticker 1” from the sticker selection panel as the input sticker. When the user clicks to select “Sticker 1”, the terminal is triggered to search for an output sticker similar to “Sticker 1” in a plurality of sticker similarity dimensions.

In this embodiment of this disclosure, there are many ways to trigger a search for an output image. For example, in an embodiment, the terminal can be triggered to search for an output image similar to the input image in a plurality of image similarity dimensions.

For example, the step 104, in which a search is performed for at least one output image similar to the input image in the plurality of image similarity dimensions, may include performing the following processing for each image similarity dimension. The processing can include extracting first feature information of the input image in the image similarity dimension; obtaining second feature information of each candidate image in an image database image in the image similarity dimension; calculating similarities between the first feature information and respective pieces of second feature information respectively; and determining a candidate image similar to the input image in the image similarity dimension in the image database as the output image according to the calculated similarities.

In this way, the terminal obtains the output image from the server for generating the search result list.

Feature information in each or each type of image similarity dimension represents information such as an attribute in the image similarity dimension, and is used for calculating information about a similarity between two images in the image similarity dimension.

For example, the feature information in the image similarity dimension may include feature information, such as text feature information and vector feature information, corresponding to content or a meaning of an image. The text feature information may include character feature information, image type information (e.g., classification tag information), and the like. The character feature information may be obtained through character recognition, and the image type information may be obtained through image classification. The vector feature information may be a feature vector (e.g., a multi-dimensional feature vector) outputted by the model when a feature extraction model is used for extraction. The feature extraction model may be a deep learning model, for example, a residual network model (ResNet) or a face recognition network model (FaceNet).

In an embodiment, the step 105, in which a search result list is generated according to the at least one output image and the search result list is displayed, may specifically include extracting third feature information of each output image; and ranking the output images according to the third feature information, and obtaining the search result list.

When the output images are determined from candidate images in the image database, the third feature information is the same as the second feature information.

In an embodiment of this disclosure, searching for an output image in at least one image similarity dimension may include: searching for an output image similar to the input image in all of a plurality of image similarity dimensions, where, for example, an output image is similar to the input image in all of an image similarity dimension 1, an image similarity dimension 2, and an image similarity dimension 3. The searching may farther include: searching for output images similar to the input image in the image similarity dimensions. For example, searching for an output image similar to the input image in the image similarity dimension searching for an output image similar to the input image in the image similarity dimension 2, and searching for an output image similar to the input image in each of the remaining image similarity dimension n, where n is a positive integer greater than 2.

Using a sticker as an example, searching for an output sticker similar to the input sticker in at least one sticker similarity dimension may include: searching for an output sticker similar to the input sticker in all of a plurality of sticker similarity dimensions, where, for example, a sticker 11 and a sticker 1 have images similarity, meaning similarity, and conversational relationship similarity. In this case, the sticker 11 is similar to the input sticker 1 in all of three dimensions. The searching may also include searching for output stickers similar to the input sticker in all sticker similarity dimensions respectively. For example, the sticker 11 and the sticker 1 have meaning similarity, a sticker 12 and the sticker 1 have role similarity, and a sticker 13 and the sticker 1 have conversational relationship similarity.

In an embodiment of this disclosure, the search result list may include an output image similar to the input image in each or each type of image similarity dimension. For example, an output sticker is similar to the input sticker m dimensions such as image similarity, meaning similarity, and conversational relationship similarity.

In actual applications, a search result can be displayed on a page. For example, when the search result is successfully obtained, a search result page is displayed, and the search result page includes the input image and the search result list. For example, referring to FIG. 1c, when the terminal successfully obtains the search result, a sticker search result page 1c4 is displayed. This page includes an input sticker 1 and output stickers similar to the input sticker 1 in respective sticker similarity dimensions, for example, a sticker 11 and a sticker 12.

In an embodiment, to help the user to use the output image that is searched out, the user may be allowed to perform an operation on the search result list to add a selected output image to favorites. For example, the image search method further includes displaying art image operation page of a target output image in the search result list in response to detecting a determining operation of the user on the target output image, the image operation page including an image addition control. The image search method further includes adding the target output image to a chat image library of the IM client in response to detecting an addition operation of the user on the image addition control.

In an embodiment, to help the user to use the output image that is searched out, the user may be allowed to perform an operation on the search result list to directly use a selected output image. For example, the image search method further includes displaying an image operation page of a target output image in the search result list in response to detecting a determining operation of the user on the target output image, the image operation page including an image transmitting control. The image search method further includes displaying a list of to-be-selected partners in response to detecting an image transmitting operation of the user on the image transmitting control, the list of to-be-selected partners including at least one to-be-selected chat partner. The image search method further includes obtaining a target chat partner selected by the user from the list of to-be-selected partners, and transmitting the target output image to the target chat partner.

The to-be-selected chat partner may be a private chat partner such as a specific user, or be a group chat partner such as a specific group.

For example, referring to FIG. 1f, after a sticker search result list is displayed, the user may select a target output sticker by performing an operation on output stickers in the list. When the user performs an operation on, for example, clicks or taps, or clicks, an output sticker, for example, an output sticker 12, in the list, the terminal may display a sticker detail page of the output sticker in an image operation page 1f1, for example, a sticker detail page of the sticker 12. The sticker detail page includes a sticker transmitting control such as a “Send to Chat” button, and a sticker adding control such as an “Add Sticker” button.

If the user wants to add the output sticker to favorites, the user may click the “Add Sticker” button. In this case, the terminal may add the sticker 12 to a sticker library of the user of the client for subsequent use by the user.

When the user wants to send and use the output sticker directly, the user may click the “Send to Chat” button. In this case, the terminal may display “Select a Chat” on a list of candidate chat partners page 1f2, and the list may include a private chat partner, a group chat partner, and the like. The user may perform an operation on the partner list page 1f2 to select a target chat partner. For example, when the chat partner is a private chat partner, the sticker 12 can be sent to a chat conversation with the private chat partner, as shown in a page 1f3. When the chat partner is a group chat partner, the sticker 12 can be sent to a group chat conversation corresponding to the group chat partner.

It can be seen from the above that in this embodiment of this disclosure, output images are searched for based on an image, that is, output images ate searched for by image (e.g., stickers are searched for by sticker), thereby achieving the search for the output image. The user does not need to input text information to search for an image, which simplifies the image search process and improves the efficiency of an image search. In addition, compared with the way of searching for images by text, searching far output images by image enables an image to include more information and better convey the user's searching needs such as content and a form of an image, so that an output image that the user needs can be searched out more accurately.

In addition, in this solution, an output image can be searched out in a plurality of image similarity dimensions, which widens the range of images that are searched out, and improves a probability of satisfying the need of the user, so that a range of the image search is widened, and accuracy thereof is improved.

In an embodiment, another device, such as a server, may also be triggered to search for an output image similar to the input image in a plurality of image similarity dimensions, and then the output image that is searched out is obtained from the other device such as the server. FIG. 2f is a flowchart of an image search method according to another embodiment of this disclosure. The image search method is performed by a server, for example, the server 120 in FIG. 1a. The method can include the following steps.

In step 401, based on an image search request transmitted by a terminal, an input image for a search is determined.

In step 402, a plurality of image similarity dimensions is preset according to levels of similarity between two chat interactive-images.

In step 403, a search is performed for at least one output image similar to the input image in the plurality of image similarity dimensions, each output image being similar to the input image in at least one image similarity dimension.

In step 404, a search result list is generated according to the at least one output image.

In step 405, the search result list is returned to the terminal, to cause the terminal to display the search result list on an interface of an IM client.

Exemplary implementations of steps 402 to 404 are the same as those of steps 103 to 105 described above, and are not specifically described herein again.

According to the method described in the foregoing embodiments, the following further provides detailed descriptions by using examples.

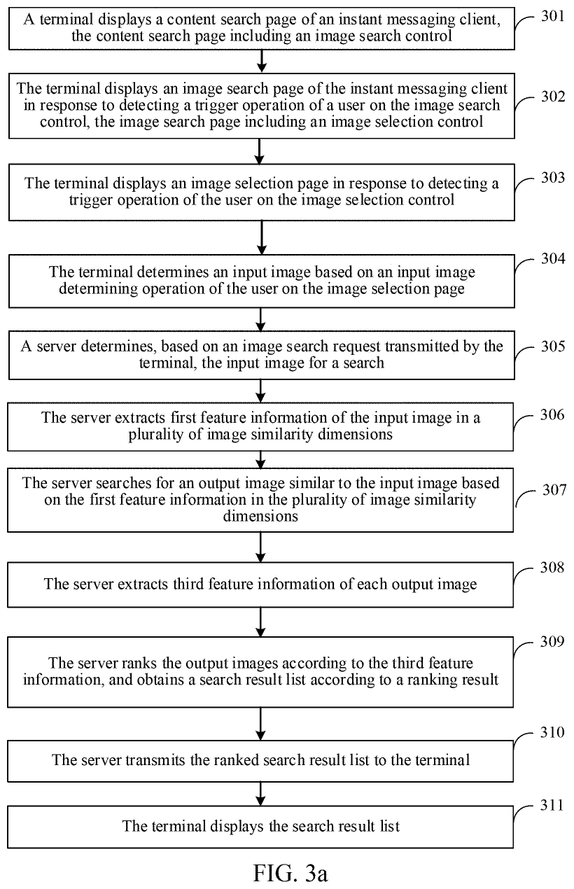

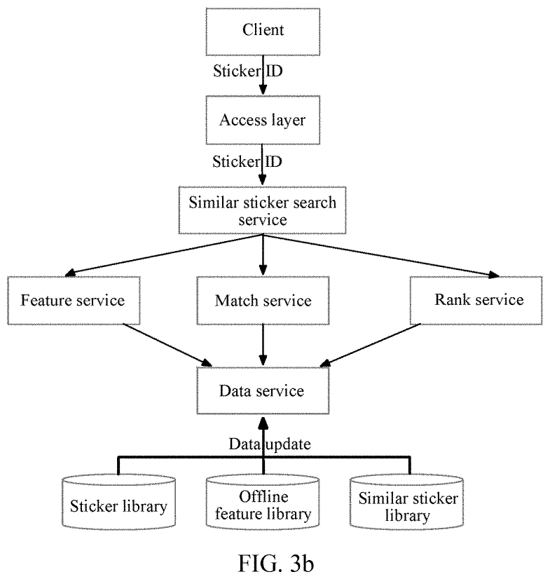

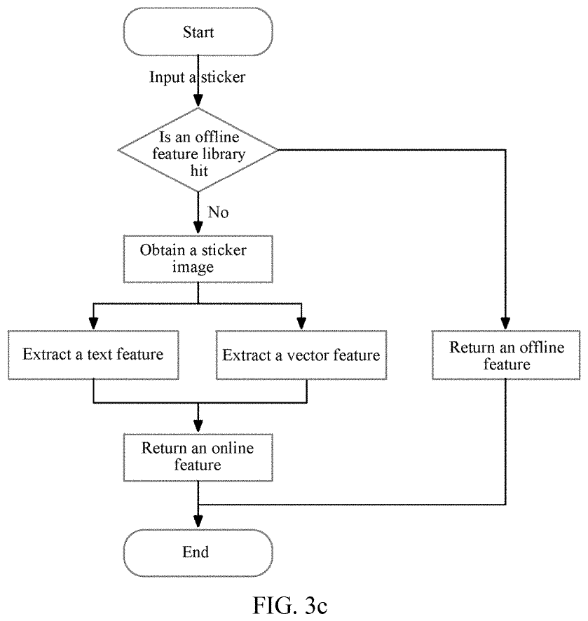

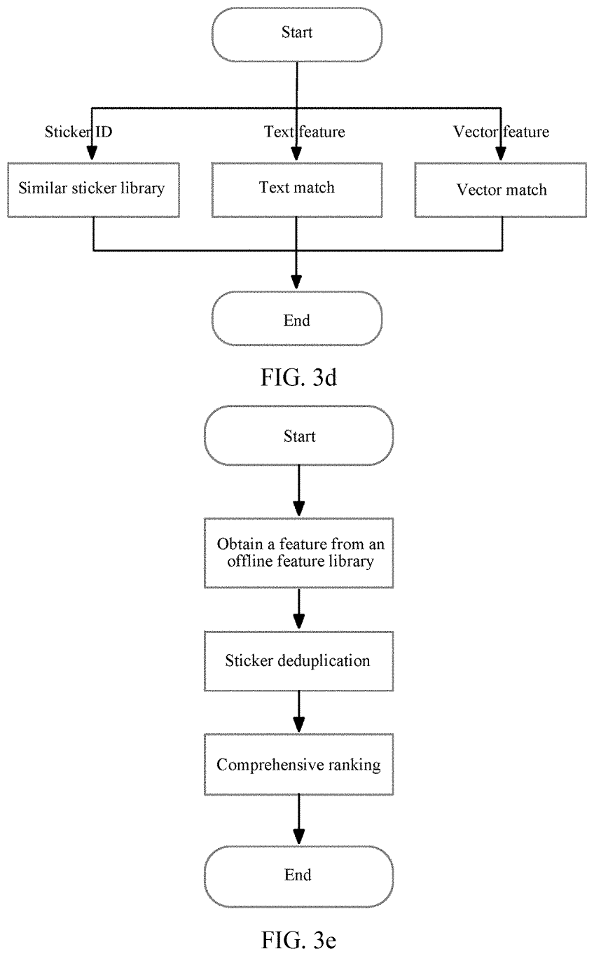

In this embodiment, an example in which the first image search apparatus is specifically integrated in a terminal and the second image search apparatus is specifically integrated in a server is used for description. As shown in FIG. 3a, an image search method is applicable to the terminal 110 and the server 120 shown in FIG. 1a, and an exemplary process thereof is as follows.

In step 301, a terminal displays a content search page of the IM client, the content search page including an image search control.

In step 302, the terminal displays an image search page of the IM client in response to detecting a trigger operation of the user on the image search control, the image search page including an image selection control.

In step 303, the terminal displays an image selection page in response to detecting a trigger operation of the user on the image selection control.

In step 304, the terminal determines an input image based on an input image determining operation of the user on the image selection page.

For exemplary implementations of the foregoing steps, reference may be made to the descriptions of the foregoing embodiment.

In another example, FIG. 3b shows a sticker search system architecture according to an embodiment of this disclosure. When the user selects an input sticker, the IM client on the terminal can transmit an image search request to an access layer, for example, an access layer server. The access layer may forward the image search request to a similar sticker search service, for example, to a similar sticker search server. The image search request may carry an input image, for example, a sticker. In an embodiment, to improve the efficiency of an image search, an image identifier of the image may be used to indicate the image for the image search. For example, the IM client may transmit an image search request carrying a sticker identifier (ID) to the access layer.

In step 305, a server determines the input image for a search based on an image search request transmitted by the terminal.

For example, the server can resolve the image search request to obtain an input image or an image ID of the input image, for example, a to-be-searched sticker ID.

In step 306, the server extracts first feature information of the input image in a plurality of image similarity dimensions.

For example, referring to FIG. 3b, a feature service module can be configured to extract feature information of the input sticker in a plurality of sticker similarity dimensions. A function of the feature service module may be implemented by another server, or the feature service module is a local service module of a server. The module can be implemented by processing circuitry, software, or a combination thereof, for example. For example, for the descriptions of the image similarity dimensions, reference may be made to the descriptions of the foregoing embodiment.

For example, there is a plurality of similarity dimensions or scenarios of stickers: image similarity, meaning similarity, conversational relationship similarity, and the like. To meet the needs of a plurality of scenarios, it is necessary to extract features in a plurality of dimensions, including a text feature obtained through character recognition, a text feature recognized by using a sticker tag, a vector feature (e.g., a multi-dimensional feature vector outputted by a model such as ResNet or FaceNet), and the like.

In an embodiment, to improve the efficiency of feature extraction and an image search, feature information of an image (which may be referred to as offline feature information) may be extracted in advance, and stored in a database (the database may be referred to as an offline feature library). During an image search, if an input image exists in the database, the image is directly extracted from the database.

For example, if the input image exists in a preset feature set, feature information corresponding to the input image in a plurality of image similarity dimensions are extracted from the preset feature set. The preset feature set includes: a preset image, and feature information corresponding to the preset image in a plurality of image similarity dimensions.

If the input image does not exist in the preset feature set, multi-dimensional feature extraction is performed on the input image to obtain feature information of the input image in a plurality of image similarity dimensions. The preset feature set may be in the form of a database, for example, an offline feature library.

In an embodiment, feature information in the plurality of image similarity dimensions may include: text feature information and vector feature information. If the input image does not exist in the preset feature set, features may be extracted in the following manner. Character recognition is performed on the input image to obtain a character recognition result, and first text feature information of the input image is constructed according to the character recognition result. Image classification is performed on the input image to obtain an image classification result, and second text feature information of the input image is constructed according to the image classification result. Further, a feature vector of the input image is extracted based on a feature extraction model to obtain a vector feature of the input image.

For example, referring to FIG. 3b, data in the offline feature library is regularly updated to the data service module for online use. The feature service module may extract the features based on the feature extraction manner described above. For example, referring to FIG. 3c, whether the input sticker hits the of feature library is first checked, that is, whether the offline feature library includes feature information of the input sticker, and if so, offline features of the input sticker in a plurality of sticker similarity dimensions are extracted from the offline feature library. If the offline feature library is not hit, an input sticker image can be obtained, and multi-dimensional feature extraction, such as text feature extraction and vector feature extraction, can be performed on the input sticker image to obtain multi-dimensional online features of the input sticker.

In step 307, the server searches for an output image similar to the input image based on the first feature information in the plurality of image similarity dimensions.

The searched output images may be combined into an output image set, and the output image set includes output images similar to the input image in at least one image similarity dimension.

For example, the server can search the image database for an image similar to the input image based on the feature information in each image similarity dimension. The image database, such as a sticker library, may include a plurality of images that can be provided to the user, for example, stickers.

In an embodiment, to improve the accuracy and richness of the search for the output image, an online output image may also be supplemented. For example, output images of some images can be preset, for example, as a list of output images, and stored in an output image database. When an output image is searched for, an output image in the output image database can be searched out to supplement the search result.

For example, the output images similar to the input image are searched for based on the first feature information in each image similarity dimension to obtain a first output image subset, and the first output image subset includes output images similar to the input image in at least one image similarity dimension.

Based on an output image mapping relationship set, a preset output image corresponding to the input image is obtained to obtain a second output image subset, where the output image mapping relationship set includes a mapping relationship between the input image and the preset output image.

The first output image subset and the second output image subset are summarized to obtain an output image set.

The output image mapping relationship set can be stored in a database, and the database can be referred to as an output image library, for example, an output sticker library.

For example, referring to FIG. 3b, after the feature service module extracts feature information of a sticker in a plurality of dimensions, a match service module may match the output sticker when a search is performed according to the extracted feature information in the plurality of dimensions. One or more modules can be implemented by processing circuitry, software, or a combination thereof. For example, referring to FIG. 3d, a similar sticker library may be searched for an output sticker. The similar sticker library is a list of similar stickers calculated offline, mines similar information in a plurality of dimensions, and is a supplement to an online matching result. The sticker library is searched for an output sticker according to a text feature (e.g., text matching). For example, text matching is performed by using a text search engine. The sticker library is searched for an output sticker according to a vector feature (e.g., vector matching). For example, text matching is performed by using a vector search engine. Then, output stickers matched in a plurality of channels are summarized to obtain the searched output sticker set.

In an embodiment, there is a plurality of implementations for searching the image database for the output image based on the feature information in the image similarity dimensions. For example, the implementations may include: for each image similarity dimension, extracting first feature information of the input image in the image similarity dimension; obtaining second feature information of each candidate image in an image database image in the image similarity dimension; calculating similarities between the first feature information and respective pieces of second feature information respectively; and determining a candidate image similar to the input image in the image similarity dimension in the image database as the output image according to the calculated similarities. For example, an image with a similarity greater than a preset similarity threshold in the image database is selected as the output image of the input image.

In step 308, the server extracts third feature information of each output image.

The third feature information of the output images may include feature information of the output images in one or more image similarity dimensions.

For example, the server can extract feature information of the output images from a preset feature set. For example, output images in similarity dimensions can be extracted from an offline feature library.

In step 309, the server ranks the output images according to the third feature information, and obtains the search result list according to a ranking result.

For example, referring to FIG. 3b and FIG. 3e, after the match service module obtains the output stickers matched in the plurality of channels, a ranking service module can rank the output stickers matched in the plurality of channels. One or more modules can be implemented by processing circuitry, software, or a combination thereof. For example, offline feature information of the output stickers (offline feature information in a plurality of image similarity dimensions) can be extracted from the offline feature library. Then, sticker deduplication is performed, and the matched output stickers are ranked based on the offline feature information of the output stickers in the plurality of image similarity dimensions, for example, are scored and ranked with reference to various stickers.

In the embodiments of this disclosure, the output images that are searched out may be ranked based on the multi-dimensional feature information of the output images that is searched out. Since ranking the output images based on the multi-dimensional feature information may convey the needs of the user for the image similarity dimensions, that is, the user needs output images similar to the input image in the dimensions, output images that meet the needs of the user rank the top, thereby improving the accuracy of searching for the output image.

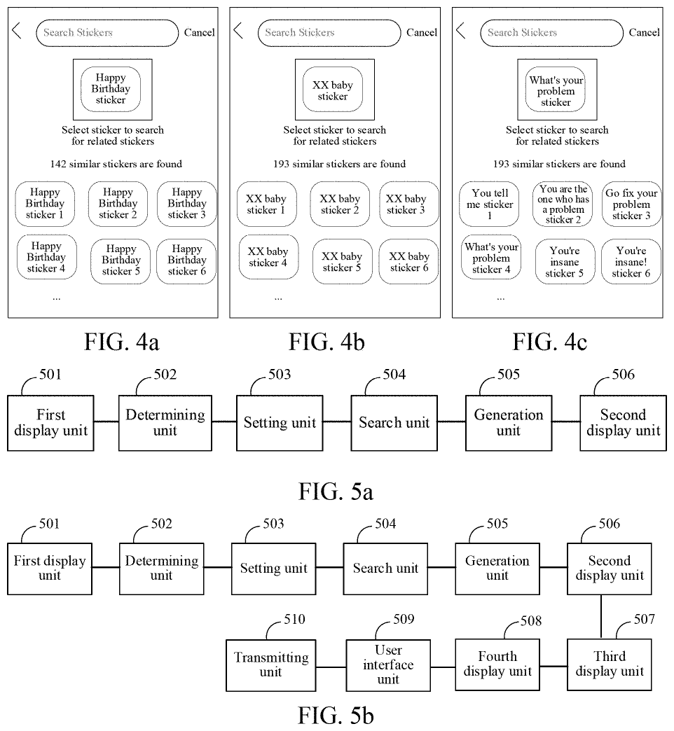

For example, in a scenario of using the output sticker, when members in a chat group congratulate, thank, or agree with something, use of the output sticker can avoid awkwardness of sending the same sticker as others, to make others believe that the thing is taken seriously and not perfunctorily. For example, members in a chat group send happy birthday stickers on a member's birthday. However, happy birthday stickers are not commonly used, and users do not add many happy birthday stickers to their favorites. Since, sending a sticker that has been sent in previous chats seems perfunctory, the users need find different stickers to send the stickers to each other. A birthday greeting sticker search result can be obtained by using the method provided in the embodiments of this disclosure, referring to FIG. 4a. In FIG. 4a, because in this use scenario, the user cares more about text content of stickers and hopes to search out an output sticker of “Happy Birthday”. Therefore, after a list of output stickers is searched out by using the method of the embodiments of this disclosure, multi-dimensional features, such as a text feature, of output stickers can be outputted, for ranking the output stickers in the list, so that stickers including “Happy Birthday” rank higher than other similar stickers in the list.

In another use scenario of the output sticker, when a user sees a sticker, likes the sticker very much, and wants to find more similar stickers, the output sticker can quickly help the user to find similar stickers that the user likes. For example, when the user receives a “XX baby” sticker and wants to obtain more stickers related to “XX baby”, the user can quickly search for a plurality of similar output stickers without inputting text.

For example, in FIG. 4b, because in this use scenario, the user cares more about a role of a sticker and hopes to search out an output sticker with the role “XX baby”, after a list of output stickers is searched out by using the method of the embodiments of this disclosure, multi-dimensional features, such as a text feature (sticker tag feature), of output stickers can be outputted, and the output stickers in the list can be ranked, so that stickers with the role “XX baby” rank higher than other output stickers in the list.

In another use scenario of the output sticker, when a user receives a sticker, the user hopes that an output sticker can provide an interesting sticker response result to increase the fun of sticker sending in a chat. For example, when the user receives a “What's your problem” sticker, output stickers may be provided as stickers, such as “You are the one who has a problem”, and “You tell me”, that may start a meme battle and sent to the other party, thereby increasing the fun of the chat.

For example, in FIG. 4c, in this use scenario, since the user cares more about the conversational relationship of stickers, and hopes to search out an output sticker having a conversational relationship with the input sticker, after a list of output stickers is searched out by using the method of the embodiments of this disclosure, multi-dimensional features, such as a text feature and a vector feature, of output stickers can be outputted, and the output stickers in the list can be ranked, so that output stickers having a conversational relationship with the input sticker rank higher than other output stickers in the list.

In step 310, the server transmits the ranked search result list to the terminal.

In an embodiment, the server may select a corresponding quantity of images from the ranked output image set and transmit the set to the terminal according to the quantity of images that need to be displayed on a terminal side.

In step 311, the terminal displays the search result list.

It can be seen from the above that in this embodiment of this disclosure, output images are searched for based on an image, that is, output images are searched for by image (e.g., stickers are searched for by sticker), thereby achieving the search for the output image. In addition, the user does not need to input text information to search for an image, which simplifies the image search process and improves the efficiency of an image search. In addition, compared with the way of searching for images by text, searching for output images by image enables an image to include more information and better convey the user's searching needs such as content and a form of an image, so that an output image that the user needs can be searched out more accurately.

In addition, in this solution, an output image can be searched out in a plurality of image similarity dimensions, which widens the range of images that are searched out, and improves a probability of satisfying the need of the user, so that a range of the image search is widened, and accuracy thereof is improved.

To better implement the foregoing method, correspondingly, an embodiment of this disclosure further provides an image search apparatus (e.g., a first image search apparatus), where the first image search apparatus may be integrated in a terminal. For example, as shown in FIG. 5a, the image search apparatus 500 is applicable to the terminal 110 shown in FIG. 1a, the apparatus can include a first display unit 501, a determining unit 502, a setting unit 503, a search unit 504, a generation unit 505, and a second display unit 506. One or more of units can be implemented by processing circuitry, software, or a combination thereof, for example.

The first display unit 501 is configured to display an image selection page of an IM client. The determining unit 502 is configured to determine, based on an operation performed by a user on the image selection page, an input image for a search. The setting unit 503 is configured to preset a plurality of image similarity dimensions according to levels of similarity between two chat interactive-images. The search unit 504 is configured to search out at least one output image similar to the input image in the plurality of image similarity dimensions, each output image being similar to the input image in at least one image similarity dimension. The generation unit 505 is configured to generate a search result list according to the at least one output image. The second display unit 506 is configured to display the search result list.

In an embodiment, the setting unit 503 is configured to pre obtain a plurality of chat interactive-images used in the IM client; and layer information included in the plurality of chat interactive-images, and setting the plurality of image similarity dimensions to any of a text content dimension, a meaning dimension, a role dimension, an action dimension, and a conversational relationship dimension.

In an embodiment, the first display unit 501 is further configured to display the input image and a search result loading icon on a search loading page of the IM client; and the second display unit 506 is configured to display the search result list, on a search result page of the IM client in a case that the search succeeds.

In an embodiment, the first display unit 501 is further configured to display a chat conversation list page of the IM client, the chat conversation list page including a content search control; and display the content search page in a case that a trigger operation of the user on the content search control is detected.

In an embodiment, the first display unit 501 is further configured to display a function page of the IM client, the function page including a search function control; and display the content search page in a case that a trigger operation of the user on the search function control is detected.

In an embodiment, the search unit 504 is configured to perform the following processing for each image similarity dimension; extracting first feature information of the input image in the image similarity dimension; obtaining second feature information of each candidate image in an image database image in the image similarity dimension; calculating similarities between the first feature information and respective pieces of second feature information respectively; and determining a candidate image similar to the input image in the image similarity dimension in the image database as the output image according to the calculated similarities.

In an embodiment, the feature information includes text feature information and/or vector feature information.

In an embodiment, the generation unit 505 is configured to extract third feature information of each output image, and rank the output images according to the third feature information, and Obtain the search result list according to a ranking result.

In an embodiment, the second display unit 506 is further configured to display an image operation page of a target output image in the search result list in a case that a determining operation of the user on the target output image is detected, the image operation page including an image addition control; and add the target output image to a chat image library of the IM client in response to detecting an addition operation of the user on the image addition control.

In the embodiment shown in FIG. 5b, the image search apparatus 500 further includes a third display unit 507, a fourth display unit 508, a user interface unit 509, and a transmitting unit 510. One or more of modules or the apparatus can be implemented by processing circuitry, software, or a combination thereof, for example.

The third display unit 507 is configured to display an image operation page of a target output image in the search result list when a determining operation of the user on the target output image is detected, the image operation page including, an image transmitting control.

The fourth display unit 508 is configured to display a list of to-be-selected partners when an image transmitting operation of the user on the image transmitting control is detected, the list of to-be-selected partners including at least one to-be-selected chat partner.

The user interface unit 509 is configured to obtain a target chat partner selected by the user from the list of to-be-selected partners.

The transmitting unit 510 is configured to transmit the target output image to the target chat partner.

To better implement the foregoing method, correspondingly, an embodiment of this disclosure further provides an image search apparatus to (e.g., a second image search apparatus), where the second image search apparatus may be integrated in a server. For example, as shown in FIG. 6a, the image search apparatus 600 is applicable to the server 120 shown in FIG. 1a, the apparatus can include a determining unit 601, a setting unit 602, a search unit 603, a generation unit 604, and a transmitting unit 605. One or more of units of the apparatus can be implemented by processing circuitry, software, or a combination thereof, for example.

The determining unit 601 is configured to determine an input image based on an image search request transmitted by a terminal.

The setting unit 602 is configured to preset a plurality of image similarity dimensions according to levels of similarity between two chat interactive-images.

The search unit 603 is configured to search out at least one output image similar to the input image in the plurality of image similarity dimensions, each output image being similar to the input image in at least one image similarity dimension.

The generation unit 604 is configured to generate a search result list according to the at least one output image.

The transmitting unit 605 is configured to return the search result list to the terminal, to cause the terminal to display the search result list on an interface of an IM client.

In an embodiment, the generation unit 604 includes an extraction subunit 6041 and a ranking subunit 6042. The extraction subunit 6041 is configured to extract third feature information of each output image. The ranking subunit 6042 is configured to rank the output images according to the third feature information, and obtain the search result list according to a ranking result.

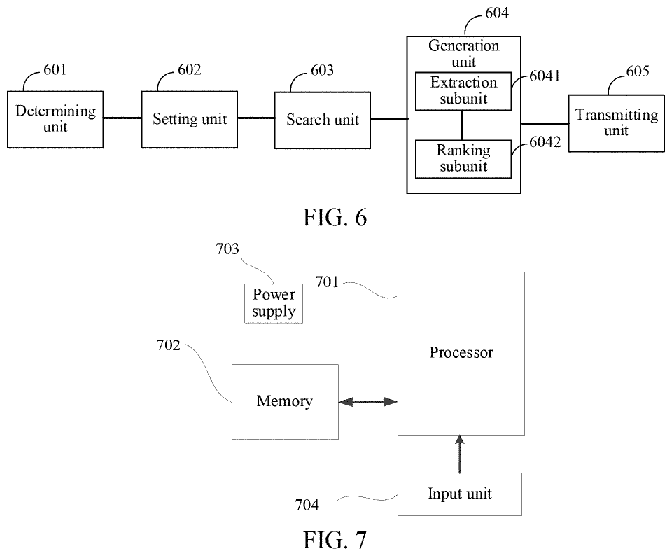

In addition, an embodiment of this disclosure further provides a computing device. The computing device may be a terminal or a server. FIG. 7 is a schematic structural diagram of a computer device according to an embodiment of this disclosure.

For example, the computer device may include components such as processing circuitry (e.g., a processor 701 including one or more processing cores), a memory 702 including one or more computer-readable storage media, a power supply 703, and an input unit 704. A person skilled in the art may understand that, the structure of the computer device shown in FIG. 7 is merely exemplary and does not constitute a limitation to the computer device. The computer device may include components that are more or fewer than those shown in the figure, or some components may be combined, or a different component deployment may be used.

The processor 701 is a control center of the computer device, and connects to various parts of the entire computer device by using various interfaces and lines. By running or executing software programs and/or modules stored in the memory 702, and invoking data stored in the memory 702, the processor performs various functions and data processing of the computer device, thereby performing overall monitoring on the computer device. The processor 701 may include one or more processing cores. The processor 701 may integrate an application processor and a modem processor. The application processor mainly processes an operating system, a user interface, an application program, and the like, and the modem processor mainly processes wireless communication. It may be understood that alternatively, the modem processor may not be integrated into the processor 701.

The memory 702 may be configured to store a software program and a module, and the processor 701 runs the software program and the module that are stored in the memory 702, to implement various functional applications and data processing. The memory 702 may mainly include a program storage area and a data storage area. The program storage area may store an operating system, an application program required by at least one function (e.g., a sound playback function and an image display function), and the like. The data storage area may store data created according to use of the computer device, and the like. In addition, the memory 702 may include a high-speed random access memory, and may also include a non-volatile memory such as at least one disk storage device, a flash memory device, or another volatile solid-state storage device. Correspondingly, the memory 702 may further include a memory controller, so that the processor 701 can access the memory 702.

The computer device further includes the power supply 703 for supplying power to the components. The power supply 703 may be logically connected to the processor 701 by using a power management system, thereby implementing functions such as charging, discharging, and power consumption management by using the power management system. The power supply 703 may further include one or more of a direct current or alternating current power supply, a re-charging system, a power failure detection circuit, a power supply converter or inverter, a power supply state indicator, and any other component.

The computer device may further include the input unit 704. The input unit 704 may be configured to receive input digit or character information and generate keyboard, mouse, joystick, optical, or trackball signal input related to user settings and function control.

Although not shown in the figure, the computer device may further include a display unit, and the like. Details are not described herein again. For example, in this embodiment, the processor 701 in the computer device may load executable files corresponding to processes of one or more application programs to the memory 702 according to the following instructions, and the processor 701 runs the application programs stored in the memory 702 to implement various functions.

For exemplary implementations of the above operations, refer to the foregoing embodiments. Details are not described herein again.

A person of ordinary skill in the art may understand that, all or some steps of the methods in the foregoing embodiments may be implemented by using instructions, or implemented through instructions controlling relevant hardware such as processing circuitry, and the instructions may be stored in a computer-readable storage medium, such a non-transitory computer-readable storage medium, and loaded and executed by a processor.

Accordingly, an embodiment of this disclosure provides a storage medium, storing a plurality of instructions. The instructions can be loaded by a processor to perform the steps in any image search method according to the embodiments of this disclosure.

The storage medium may include a read-only memory (ROM), a random access memory (RAM), a magnetic disk, an optical disc, or the like.

Because the instructions stored in the storage medium is to perform the steps of any image search method provided in the embodiments of this disclosure, the instructions can implement beneficial effects that can be implemented by any image search method provided in the embodiments of this disclosure. For exemplary details, reference may be made to the foregoing embodiments. Details are not described herein again.

The image search method and apparatus, the computer device, and the storage medium provided in the embodiments of this disclosure are described above in detail. Although the principles and implementations of this disclosure are described by using specific examples in this disclosure, the descriptions of the foregoing embodiments are merely intended to help understand the method and the core idea of this disclosure. Meanwhile, a person skilled in the art may make modifications to the specific implementations and disclosure according to the idea of this disclosure. In conclusion, the content of this specification is not to be construed as a limitation to this disclosure.

What is claimed is:

1. An image search method, comprising:
displaying an image selection page of a messaging application;
determining an input image for a search based on an operation performed by a user on the image selection page;
searching for at least one output image similar to the input image based on a plurality of types of image characteristics that indicate levels of similarity between images, each of the at least one output image being determined to be similar to the input image based on at least one of the types of image characteristics;
generating a search result list according to the at least one output image; and
displaying, by processing circuitry, the search result list.

2. The image search method according to claim 1, wherein
the image selection page includes at least one first image; and
the determining includes determining, in response to a selection of one of the at least one first image, the selected one of the at least one first image as the input image.

3. The image search method according to claim 1, wherein
the image selection page includes an image capture control element; and
the determining includes:
displaying an image capture page in response to a selection of the image capture control element;
displaying a capture result page based on a capture operation received via the image capture page, the capture result page including a captured image and an image confirmation control element; and
determining the captured image as the input image in response to a selection of the image confirmation control element.

4. The image search method according to claim 1, wherein
the image selection page includes a photo selection control element; and
the determining includes:
displaying a photo selection page in response to selection of the photo selection control element, the photo selection page including, at least one photo;
labeling, based on a photo selection operation received via the photo selection page photo selected by the user in the photo selection page, and displaying a photo confirmation page, the photo confirmation page including a photo confirmation control element; and
determining, in response to a selection of the photo confirmation control element, the photo selected by the user as the input image.

5. The image search method according to claim 1, wherein
the image selection page includes a speech selection control element; and
the determining includes:
displaying a speech input page in response to selection of the speech selection control element, the speech input page including a speech input control element;
acquiring, in response to selection of the speech input control element, speech information inputted by the user;
displaying candidate images matching the speech information; and
determining, in response to selection of a candidate image of the candidate images, the selected candidate image as the input image.

6. The image search method according to claim 1, wherein
the image selection page includes an image drawing control element; and
the determining includes:
displaying an image drawing page in response to selection of the image drawing control element, the image drawing page including an image drawing region;
displaying, based on a drawing operation of the user in the image drawing region, an image drawn by the user on the image drawing page; and
determining the image drawn by the user as the input image.

7. The image search method according to claim 1, further comprising:
pre-obtaining a plurality of images used in the messaging application;
determining information included in the plurality of images; and
setting the plurality of types of image characteristics to any of text content, meaning, role, action, and conversational relationship.

8. The image search method according to claim 1, further comprising:
displaying the input image and a search result loading icon on a search loading page of the messaging application,
wherein the generating includes displaying the search result list on a search result page of the messaging application when the search is completed.

9. The image search method according to claim 1, further comprising:
displaying a content search page of the messaging application the content search page including an image search control element; and
displaying an image search page of the messaging application in response to selection of the image search control element, the image search page including an image selection control element
wherein the displaying the image selection page includes displaying, the image selection page in response to selection of the image selection control element.

10. The image search method according to claim 9, further comprising:
displaying a chat conversation list page of the messaging application, the chat conversation list page including a content search control element; and
displaying the content search page in response to selection of the content search control element.

11. The image search method according to claim 9, further comprising:
displaying a function page of the messaging application, the function page including a search function control element; and
displaying the content search page in response to selection of the search function control element.

12. The image search method according to claim 1, wherein the searching comprises:
performing, for each of the types of image characteristics;
extracting first feature information of the input image of the respective type of image characteristic;
obtaining second feature information of each candidate image in an image database of the respective type of image characteristic;
calculating similarities between the first feature information and respective pieces of the second feature information; and
determining a candidate image similar to the input image in the respective type of image characteristic in the image database as the output image according to the calculated similarities.

13. The image search method according to claim 12, wherein the first and second feature information includes at least one of text feature information or vector feature information.

14. The image search method according to claim 1, wherein the generating comprises:
extracting third feature information of each output image;
ranking the at least one output image according to the third feature information; and
obtaining the search result list according to the ranked at least one output image.

15. The image search method according to claim 1, further comprising:
displaying, in response to selection of a target output image in the search result list, an image operation page of the target output image, the image operation page including an image addition control element; and
adding the target output image to an image library of the messaging application in response to selection of the image addition control element.

16. The image search method according to claim 1, further comprising:
displaying an image operation page of a target output image in the search result list in response to selection of the target output image, the image operation page including an image transmitting control element; and
displaying a list of message targets in response to selection of the image transmitting control element, the list of message targets comprising at least one to-be-selected chat partner;
obtaining a target chat partner selected by the user from the list of message targets; and
transmitting the target output image to the target chat partner.

17. An image search method, comprising:
receiving an image search request from a terminal;
determining an input image for a search based on the received image search request;
searching for at least one output image similar to the input image based on a plurality of types of image characteristics that indicate levels of similarity between images, each of the at least one output image being determined to be similar to the input image based on at least one of the types of image characteristics;
generating a search result list according to the at least one output image; and
providing the search result list to the terminal, the search result list being displayed on an interface of a messaging application.

18. The image search method according to claim 17, further comprising:
pre-obtaining a plurality of images used in the messaging application;
determining information included in the plurality of images; and
setting the plurality of types of image characteristics to any of text content, meaning, role, action, and conversational relationship.

19. An image search apparatus, comprising:
processing circuitry configured to:
display an image selection page of a messaging application;
determine an input image for a search based on an operation performed by a user on the image selection page;
search for at least one output image similar to the input image based on a plurality of types of image characteristics that indicate levels of similarity between images, each of the at least one output image being determined to be similar to the input image based on at least one of the types of image characteristics;
generate a search result list according to the at least one output image; and
display the search result list.

20. A non-transitory computer-readable storage medium storing instructions which when executed by a processor cause the processor to perform the image search method according to claim 1.
